(19) United States
(12) Patent Application Publication
(10) Pub. No.: US 2024/0180382 A1
(43) Pub. Date: Jun. 6, 2024

(54) ON-BOARD INFORMATION DISPLAY

(71) Applicant: Nilfisk A/S, Copenhagen (DK)

(72) Inventor: Alexandros Matthaios, Slangerup (DK)

(21) Appl. No.: 18/504,842

(22) Filed: Nov. 8, 2023

Related U.S. Application Data
(60) Provisional application No. 63/429,395, filed on Dec. 1, 2022.

(51) Int. Cl. A47L 11/40; G06F 3/14; G06F 3/147; G06V 20/50; G06V 40/10

(52) U.S. Cl. CPC A47L 11/4008; A47L 11/4011; G06F 3/1423; G06F 3/147; G06V 20/50; G06V 40/10

(57) ABSTRACT

A method of operating a cleaning machine can include determining if a human is detected nearby. If a human is not detected, the process can restart. If a human is detected, then a determination can be made if there is emergency information to show. If there is emergency information to be shown, then the emergency information can be shown. If there is no emergency information to be shown, then an attention seeking mode can be enabled. The presence of a target group can be determined. The availability of content relevant to the target group can be determined. If content relevant to the target group is available, then the content can be displayed. If content relevant to the target group is not available, then the method can restart or return to a previous step.

### CROSS-REFERENCE TO RELATED APPLICATION(S)

This application claims the benefit of U.S. Provisional Application No. 63/429,395 filed Dec. 1, 2022 for “ON-BOARD INFORMATION DISPLAY” by A. Matthaios.

### BACKGROUND

The present disclosure generally relates to cleaning machines. In particular, the present disclosure relates to displaying information and/or images on a cleaning machine.

Industrial and commercial floors are cleaned on a regular basis for aesthetic and sanitary purposes. There are many types of industrial and commercial floors ranging from hard surfaces such as concrete, terrazzo, wood, and the like, which can be found in factories, schools, hospitals, and the like, to softer surfaces such as carpeted floors found in restaurants and offices. Different types of floor cleaning equipment such as vacuums, scrubbers, sweepers, and extractors, have been developed to properly clean and maintain these different floor surfaces.

Existing cleaning machines are seen by some as visual disturbance or points of annoyance as the cleaning machine passes by. For example, some existing cleaning machines lack features providing for visual engagement with passers-by.

### SUMMARY

A method of operating a cleaning machine can include determining a presence of a target group. An availability of content relevant to the target group can be determined. The content relevant to the target group can be displayed with a display of the cleaning machine.

A cleaning machine includes a sensor and a display. The sensor is connected to the cleaning machine and is configured to recognize an object and detect a person in a vicinity of the cleaning machine. The display is mounted to the cleaning machine and is disposed to show information to people in proximity to the cleaning machine.

A method of displaying content on a cleaning machine can include detecting a presence of a human. Whether there is emergency content to be shown can be determined. If there is emergency content to show, then the emergency content can be shown. If there is not emergency content to show, then an attention seeking mode can be enabled. A target group can be determined. Whether content relevant to the determined target group is available can be determined. Content relevant to the determined target group can be shown in response to the availability of content relevant to the determined target group.

### BRIEF DESCRIPTION OF THE DRAWINGS

FIG. 1 is a perspective view of a first cleaning machine with front and side displays.

FIG. 2 is a perspective view of a second cleaning machine with front and side displays.

FIG. 3 is a flowchart of a method of displaying content on a cleaning machine that is relevant to a target group.

### DETAILED DESCRIPTION

The present inventors have recognized, among other things, that an area of improvement with existing cleaning machines is the low level of engagement with people passing by the cleaning machine as the cleaning machine is in use. Cleaning areas with large amounts of people are cleaned with cleaning machines that are seen by many throughout the space.

The present disclosure provides an on-board display attached to a cleaning machine for displaying information to people such as people passing by the cleaning machine (or people the machine is passing by). The on-board display can show sponsored information and advertisements (e.g., marketing material) that can be curated based upon a target audience.

In this way, instead of a cleaning machine being an “inconvenience” for surrounding people, the cleaning machine can add value to a cleaning machine customer and to the customers clients. With on-board information displays, cleaning machines can add value to the surrounding people and also create a new revenue stream for cleaning machine customers. In view of the present disclosure, cleaning machines can provide revenue and/or reduce the lifetime cost for customers of the cleaning machine by showing sponsored information and advertisements on the displays of the cleaning machine.

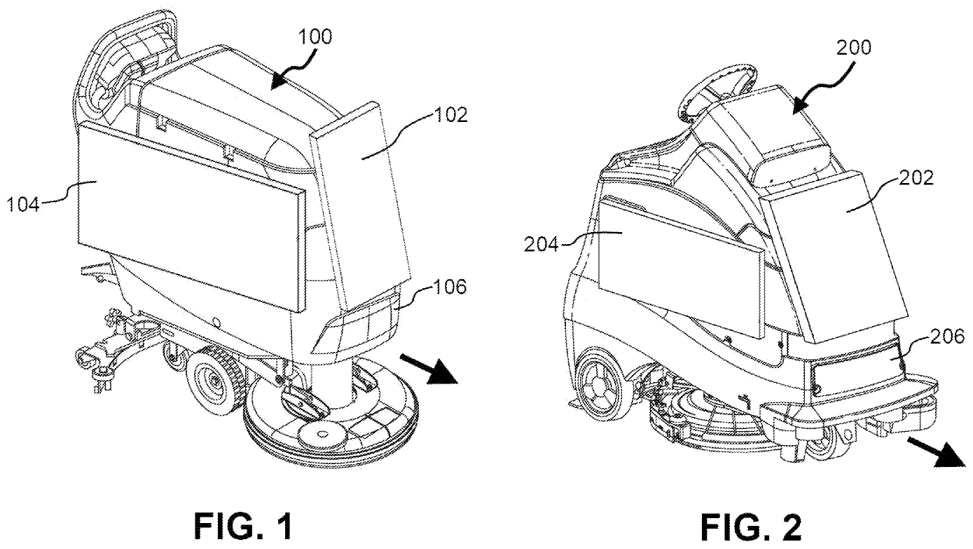

FIG. 1 is a perspective view of cleaning machine 100 with first display 102 and second display 104. In this embodiment, cleaning machine 100 includes two displays. In other embodiments, first display 102, second display 104, or a combination thereof can include a plurality of displays. As shown in FIG. 1, cleaning machine 100 can also include sensor 106.

In an embodiment, cleaning machine 100 can be a walk-behind type of machine configured to be operated by an operator. In other embodiments, cleaning machine 100 can be a robotic or autonomous machine configured to be operated and/or driven without an operator in close proximity to cleaning machine 100.

First display 102 can be mounted on a front of cleaning machine 100. In an embodiment, first display 102 can be mounted on the front of cleaning machine 100 with fixed brackets, sliders, or a combination thereof to slide in a higher or lower position (e.g., a lower position for storage and a higher position during use of cleaning machine 100).

Second display 104 can be mounted on a side of cleaning machine 100. In an embodiment, second display 104 can be mounted on the side of cleaning machine 100 with fixed brackets, sliders, or a combination thereof to slide in a higher or lower position (e.g., a lower position for storage and a higher position during use of cleaning machine 100).

In an embodiment, first display 102, second display 104, or a combination thereof can be disposed to rotate into a first vertical orientation, a second horizontal orientation, or any other angle along a range of 360°.

In an embodiment, first display 102, second display 104, or a combination thereof can include one or more displays stacked vertically, horizontally, or a combination thereof. Additionally or alternatively, horizontally or vertically configured sliders can be used to interchange and/or reposition display pieces.

In an embodiment, first display 102, second display 104, or a combination thereof can include one or more flat screens, curved screens, or flexible screens that can wrap around a portion of cleaning machine 100.

In an embodiment, first display 102, second display 104, or a combination thereof can include one or more physical ports, processors, transmitters, transceivers, and local storage devices, such as for use in areas without any wireless signal ability.

In an embodiment, first display 102, second display 104, or a combination thereof can communicate directly, or via a component of cleaning machine 100, wirelessly to an external communication device. For an example, cleaning machine 100, first display 102, second display 104, or a combination thereof can connect to an online portal that will enable remote control of information, images, or a combination thereof displayed on first display 102, second display 104, or a combination thereof. Content can be “uploaded” to cleaning machine 100 locally or remotely through wireless technology or via an internet connection.

In another embodiment, a video or data feed can be streamed (e.g., a delayed stream or a live stream) can also be displayed on first display 102, second display 104, or a combination thereof. For example, communication with remote assistance can occur via first display 102, second display 104, or a combination thereof.

In an embodiment, first display 102, second display 104, or a combination thereof can be connected to an alarm system, to a national emergency service (e.g., online or wirelessly), or to private/public authorities to guide and instruct people in case of an emergency. For example, first display 102, second display 104, or a combination thereof can show an exit route, current developments, or any other information useful to the people in proximity to cleaning machine 100.

In another embodiment, information displayed upon first display 102, second display 104, or a combination thereof could be relevant to the operating site. For example, in a market or store, a portion of first display 102, second display 104, or a combination thereof can present current offers, and another portion can show commercials for products. Additionally or alternatively, a themed message (e.g., seasonal, holiday, etc.) can also be displayed in connection with occurrences of celebrations such as religious holidays, national holidays or the like.

In an embodiment, first display 102, second display 104, or a combination thereof can be grouped by different criteria in the portal, such as by a geographical region that cleaning machine 100 operates in, target customer groups, or any other criteria or information assignable to a target audience.

In an embodiment, first display 102, second display 104, or a combination thereof can include one or more camera systems to detect and/or identify people in a vicinity of cleaning machine 100. For example, one or more camera systems can be integrated into first display 102, second display 104, or a combination thereof. Additionally or alternatively, a camera can be externally mounted to first display 102 or second display 104. Likewise, cameras or sensors of cleaning machine 100 can be used to detect and/or identify people in a vicinity of cleaning machine 100.

In an embodiment, a component of (e.g., sensor 106) or connected to cleaning machine 100 can be configured to recognize objects and characteristics of such objects. For example, a processor connected to cleaning machine 100 can utilize an algorithm to scan an image, a video, or a combination thereof collected by cleaning machine 100 to determine a type, size, or other characteristic of an object that is nearby cleaning machine 100. In an embodiment, cleaning machine 100 can use facial recognition to classify bystanders and sort the bystanders into groups in order to show content to the bystander(s) that is relevant to a certain interest group or groups.

FIG. 2 is a perspective view of cleaning machine 200 with first display 202 and second display 204.

FIG. 2 is a perspective view of cleaning machine 200 with first display 202 and second display 204. In this embodiment, cleaning machine 200 includes two displays. In other embodiments, first display 202, second display 204, or a combination thereof can include a plurality of displays. As shown in FIG. 2, cleaning machine 200 can also include sensor 206.

In an embodiment, cleaning machine 200 can be a ride-on type of machine configured to be operated by an operator positioned on or in cleaning machine 200. In other embodiments, cleaning machine 200 can be a robotic or autonomous machine configured to be operated and/or driven without an operator in close proximity to cleaning machine 200.

First display 202 can be mounted on a front of cleaning machine 200. In an embodiment, first display 202 can be mounted on the front of cleaning machine 200 with fixed brackets, sliders, or a combination thereof to slide in a higher or lower position (e.g., a lower position for storage and a higher position during use of cleaning machine 200).

Second display 204 can be mounted on a side of cleaning machine 200. In an embodiment, second display 204 can be mounted on the side of cleaning machine 200 with fixed brackets, sliders, or a combination thereof to slide in a higher or lower position (e.g., a lower position for storage and a higher position during use of cleaning machine 200).

In an embodiment, first display 202, second display 204, or a combination thereof can be disposed to rotate into a first vertical orientation, a second horizontal orientation, or any other angle along a range of 360°.

In an embodiment, first display 202, second display 204, or a combination thereof can include one or more displays stacked vertically, horizontally, or a combination thereof. Additionally or alternatively, horizontally or vertically configured sliders can be used to interchange and/or reposition display pieces.

In an embodiment, first display 202, second display 204, or a combination thereof can include one or more flat screens, curved screens, or flexible screens that can wrap around a portion of cleaning machine 200.

In an embodiment, first display 202, second display 204, or a combination thereof can include one or more physical ports, processors, transmitters, transceivers, and local storage devices, such as for use in areas without any wireless signal ability.

In an embodiment, first display 202, second display 204, or a combination thereof can communicate directly, or via a component of cleaning machine 200, wirelessly with an external communication device. For an example, cleaning machine 200, first display 202, second display 204, or a combination thereof can connect to an online portal that will enable remote control of information, images, or a combination thereof displayed on first display 202, second display 204, or a combination thereof. Content can be “uploaded” to cleaning machine 200 locally or remotely through wireless technology or via an internet connection.

In another embodiment, a video or data feed can be streamed (e.g., a delayed stream or a live stream) can also be displayed on first display 202, second display 204, or a combination thereof. For example, communication with remote assistance can occur via first display 202, second display 204, or a combination thereof.

In an embodiment, first display 202, second display 204, or a combination thereof can be connected to an alarm system, to a national emergency service (e.g., online or wirelessly), or to private/public authorities to guide and instruct people in case of an emergency. For example, first display 202, second display 204, or a combination thereof can show an exit route, current developments, or any other information useful to the people in proximity to cleaning machine 200.

In another embodiment, information displayed upon first display 202, second display 204, or a combination thereof could be relevant to the operating site. For example, in a market or store, a portion of first display 202, second display 204, or a combination thereof can present current offers, and another portion can show commercials for products. Additionally or alternatively, a themed message (e.g., seasonal, holiday, etc.) can also be displayed in connection with occurrences of celebrations such as religious holidays, national holidays, or the like.

In an embodiment, first display 202, second display 204, or a combination thereof can be grouped by different criteria in the portal, such as by a geographical region that cleaning machine 200 operates in, target customer groups, or any other criteria or information assignable to a target audience.

In an embodiment, first display 202, second display 204, or a combination thereof can include one or more camera systems to detect and/or identify people in a vicinity of cleaning machine 200. For example, one or more camera systems can be integrated into first display 202, second display 204, or a combination thereof. Additionally or alternatively, a camera can be externally mounted to first display 202 or second display 204. Likewise, cameras or sensors of cleaning machine 200 can be used to detect and/or identify people in a vicinity of cleaning machine 200.

In an embodiment, a component of (e.g., sensor 206) or connected to cleaning machine 200 can be configured to recognize objects and characteristics of such objects. For example, a processor connected to cleaning machine 200 can utilize an algorithm to scan an image, a video, or a combination thereof collected by cleaning machine 200 to determine a type, size, or other characteristic of an object that is nearby cleaning machine 200. In an embodiment, cleaning machine 200 can use facial recognition to classify bystanders and sort the bystanders into groups in order to show content to the bystander(s) that is relevant to a certain interest group or groups.

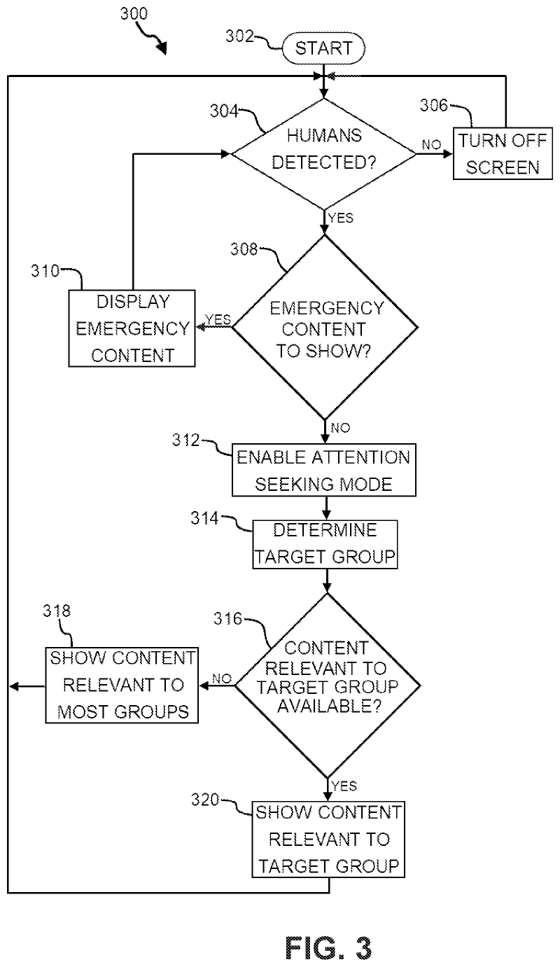

FIG. 3 is a flowchart of method 300 of displaying content on a cleaning machine (e.g., cleaning machine 100 or cleaning machine 200). Method 300 can include steps 302-320.

Step 302 can include starting method 300. Step 304 can include detecting if a human or humans are present. If a human is not detected in step 304, then step 306 can be performed. Step 306 can include turning off a display screen to preserve power. After completion of step 306, the process can return to step 302 or step 304. If a human is detected in step 302, then the method can proceed to step 308.

Step 308 can include determining if there is emergency content to show. If there is emergency content to show, then the method can proceed to step 310. Step 310 can include displaying emergency content. After completion of step 310, the process can return to step 304. If there is not emergency content to show at step 308, step 312 can occur.

Step 312 can include enabling an “attention seeking” mode. Step 314 can include determining a target group. Step 316 can include determining if content relevant to the determined target group is available. If there is no content relevant to the determined target group is available in step 316, then step 318 can occur. Step 318 can include showing content relevant to most groups. After completion of step 318, the process can return to step 302 or 304. If content relevant to the determined target group is available in step 316, then step 320 can occur. Step 320 can include showing content that is relevant to the determined target group. After execution of step 320, method 300 can repeat or terminate.

The above detailed description includes references to the accompanying drawings, which form a part of the detailed description. The drawings show, by way of illustration, specific embodiments in which the disclosure can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

I claim:

1. A method of operating a cleaning machine, wherein the method comprises:
determining a presence of a target group;
determining an availability of content relevant to the target group; and
displaying, with a display of the cleaning machine, the content relevant to the target group.

2. The method of claim 1, wherein the method further comprises:
determining if a human is nearby the cleaning machine;
determining if there is emergency information to show; and
showing, with a display of the cleaning machine, the emergency information.

3. The method of claim 1, the method further comprising:
classifying a bystander; and
showing content, with a display mounted to the cleaning machine, to the bystander based on the classifying of the bystander.

4. The method of claim 1, the method further comprising:
sorting bystanders into groups; and
showing content, with a display mounted to the cleaning machine, to the bystanders based on the sorting of the bystanders into groups.

5. The method of claim 1, the method further comprising:
collecting, with the cleaning machine, an image, a video, or a combination thereof;
scanning, with an algorithm, the image, the video, or the combination thereof collected by the cleaning machine; and
determining, with a processor, a type or a size of an object that is nearby cleaning machine in response to scanning the image, the video, or the combination thereof collected by the cleaning machine.

6. A cleaning machine comprising:
a sensor connected to the cleaning machine, wherein the sensor is configured to recognize an object and to detect a person in a vicinity of the cleaning machine; and
a display mounted to the cleaning machine, wherein the display is disposed to show information to people in proximity to the cleaning machine.

7. The cleaning machine of claim 6, wherein the display is mounted to the cleaning machine with a bracket, a slider, or a combination thereof.

8. The cleaning machine of claim 6, wherein the display is connected to an alarm system.

9. The cleaning machine of claim 6, the cleaning machine further comprising a camera system configured to detect people in a vicinity of the cleaning machine.

10. The cleaning machine of claim 9, wherein the camera system is configured to identify people in the vicinity of the cleaning machine.

11. The cleaning machine of claim 6, wherein the display is connected to remote assistance.

12. The cleaning machine of claim 6, wherein the display is connected to an online portal to enable remote control of information, an image, or a combination thereof displayed on the display.

13. A method of displaying content on a cleaning machine, wherein the method comprises:
i. detecting a presence of a human;
ii. determining if there is emergency content to show,
wherein if there is emergency content to show, then show the emergency content;
wherein if there is not emergency content to show, then proceed to step (iii),
iii. enabling an attention seeking mode;
iv. determining a target group;
v. determining if content relevant to the determined target group is available; and
vi. showing content relevant to the determined target group in response to content relevant to the determined target group being available.
